(19) United States
(12) Patent Application Publication
(10) Pub. No.: US 2025/0357579 A1
(43) Pub. Date: Nov. 20, 2025

(54) SUBMERGED LIQUID-COOLED MODULAR BATTERY SYSTEM

(71) Applicant: Clean Electric Private Limited, Bhopal (IN)

(72) Inventors: Abhinav ROY, Begusarai (IN); Akash GUPTA, Bhopal (IN); Ankit JOSHI, Nimbahera (IN)

(73) Assignee: Clean Electric Private Limited, Bhopal (IN)

(21) Appl. No.: 18/870,851

(22) PCT Filed: Apr. 14, 2023
(86) PCT No.: PCT/IN2023/050362

§ 371 Date: Dec. 2, 2024

(30) Foreign Application Priority Data
Jun. 1, 2022 (IN) 202221031343

(51) Int. Cl. H01M 10/6568; H01M 10/613; H01M 10/6551; H01M 50/204; H01M 50/224; H01M 50/264; H01M 50/276; H01M 50/503; H01M 50/51

(52) U.S. Cl. CPC H01M 10/6568; H01M 10/613; H01M 10/6551; H01M 50/204; H01M 50/224; H01M 50/264; H01M 50/276; H01M 50/503; H01M 50/51

(57) ABSTRACT

A submerged liquid-cooled modular battery system (100) comprising a battery enclosure (102) with a pair of open faces (104), a plurality of end plates (106), a plurality of sealing nuts (108), an aluminium casing (114), a pressure equalization valve (116), and a pair of handles (126). The battery enclosure (102) is front portion of the submerged liquid-cooled modular battery system (100), and comprises of a pair of open faces (104). The battery enclosure (102) is configured to enclose a plurality of battery modules. A coolant pump (146) is provided which is configured to provide a passage for dielectric coolant to circulate through the plurality of battery current collector plates (132), and intake dielectric coolant from bottom of at least one battery module, and pump the dielectric coolant inside a battery assembly (128).

### FIELD OF THE DISCLOSURE

This invention generally relates to a field of electric vehicle batteries, and more specifically relates to a submerged liquid-cooled modular battery system configured to increase life of battery modules in two or three-wheeler vehicles, without requiring need for thermal components due to space constraints.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

A battery is a device that converts chemical energy of its cell components into electrical energy. It contains two materials that cannot undergo an oxidation-reduction reaction directly, but these two materials can undergo only if electrons are allowed to travel from one material to another material, through an outside circuit while ions simultaneously travel within the cell. Battery cells needs to be balanced to offer optimal performance, meaning that they must all have the same voltage. The battery cells are rebalanced during charges, but they lose their ability to maintain that balance as they age. The battery cells are housed within a battery module. The battery module stores electrical energy to provide power to an electrical system, like an electric vehicle or an energy storage system. The energy is stored in the battery cells that are all connected to one another in the battery module.

Considering current scenario of battery designs, there are different types of the battery designs which are available in market. One battery design require series connection of multiple battery cells to boost voltage of the battery module. Some designs use small-capacity cells. To achieve desired battery energy, the small-capacity cells are connected in parallel to boost capacity of battery pack or the battery module. The battery pack is made of multiple, smaller sections called battery modules. These battery modules include a small number of cells connected in series or parallel. The cells are usually operable at a lower voltage, which is safe for handling. One best example of a battery design is “Electric Vehicle (EV) Battery” design. The EV battery is typically made of 4 to 40 modules connected in series to one another.

The present batteries in market employed for two and three-wheeler vehicles are air cooled or sometimes without any cooling. This results in significant temperature differences within the battery module and also within the battery cell because of a small contact area for heat transfer. External radiators and pumps can also not be used in such space-constrained applications. Liquid cooling with external components (radiators/pump/filters) is not feasible in batteries designed for swapping applications. These battery modules cannot be fast charged also and take several hours to charge. Fast charging the battery modules reduce battery life significantly and is not very safe too. As these battery modules are air cooled with or without heat sink/fins with a small contact area between the cell and the inside of the battery enclosure using thermal pads for heat transfer, the life of these battery modules become quite low compared to the battery cells used for making the battery module. The reason for it is higher operating temperature than ambient temperature, due to without refrigerated cooling and temperature inhomogeneity within the battery module and inside the battery cell.

Hence, in view of the above, it is desired to address above mentioned disadvantages or other shortcomings by providing a submerged, thoroughly designed, and modular battery system configured to increase life of battery modules in two or three-wheeler vehicles, without requiring need for external components due to space constraints, thereby saving charging time and efforts and eventually money or at least provide a useful alternative.

### Objectives of the Invention

It is an objective of the invention to provide a submerged liquid-cooled modular battery system configured to increase life of battery modules in two or three-wheeler vehicles.

It is an objective of the invention to provide the submerged liquid-cooled modular battery system that does not require need for external components due to space constraints.

It is an objective of the invention to provide the submerged liquid-cooled modular battery system that enables sharing of components between battery modules of different capacities.

It is an objective of the invention to provide the submerged liquid-cooled modular battery system which comprises a set of tooling used for multiple products, thereby delivering better economics.

It is an objective of the invention to provide the submerged liquid-cooled modular battery system which has simple structure.

It is an objective of the invention to provide the submerged liquid-cooled modular battery system which is cost effective.

### SUMMARY

According to a main aspect, the present embodiments disclose a submerged liquid cooled modular battery system, to increase life of battery modules in two or three-wheeler vehicles, without requiring need for external components due to space constraints. The submerged liquid cooled modular battery system comprises a battery enclosure, a plurality of end plates, a battery assembly, a plurality of battery modules, and a coolant pump. The battery enclosure comprises a pair of open faces. The plurality of end plates is configured to be detachably coupled to each of the pair of open faces, through a plurality of gaskets. The battery assembly comprises of the plurality of battery modules, with each of the plurality of battery modules configured to be sealed through tightened and detachable arrangement of the plurality of end plates with the pair of open faces. The battery assembly comprises of a coolant pump integrated within the battery assembly, and configured to provide a passage for dielectric coolant to circulate through the plurality of battery modules. The coolant pump is further configured to intake dielectric coolant from bottom of at least one battery module, and pump the dielectric coolant inside the battery assembly.

The battery enclosure, the pair of open faces, the plurality of end plates, the battery assembly, the plurality of battery modules, the plurality of battery current collectors, and the coolant pump are integrated as a single unit to form the submerged liquid-cooled modular battery system.

It is to be understood that both the foregoing general description and the following detailed description are exemplary and explanatory only and are not restrictive of the invention, as claimed.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an isometric view of a submerged liquid-cooled modular battery system, according to an embodiment of the present invention;

FIG. 2 illustrates a top view of the submerged liquid-cooled modular battery system, according to another embodiment of the present invention;

FIG. 3 illustrates a side view of the submerged liquid-cooled modular battery system, according to an exemplary embodiment of the present invention;

FIG. 4 illustrates a bottom view of the submerged liquid-cooled modular battery system, according to another exemplary embodiment of the present invention;

FIG. 5 illustrates another side view of the submerged liquid-cooled modular battery system, according to another exemplary embodiment of the present invention;

FIG. 6 illustrates another isometric view of the submerged liquid-cooled modular battery system, according to another exemplary embodiment of the present invention;

FIG. 7 illustrates another isometric view of the submerged liquid-cooled modular battery system without a casing, according to one exemplary embodiment of the present invention;

FIG. 8 illustrates another isometric view of the submerged liquid-cooled modular battery system with two modules, according to another exemplary embodiment of the present invention;

FIG. 9 illustrates another side view of the submerged liquid-cooled modular battery system with a transparent casing, according to one exemplary embodiment of the present invention;

FIG. 10 illustrates isometric view of the submerged liquid-cooled modular battery system with hidden battery modules, according to another exemplary embodiment of the present invention;

FIG. 11 illustrates an isometric view of the battery module, according to one embodiment of the present invention; and

FIG. 12 illustrates top view of the battery module, according to another embodiment of the present invention.

### DETAILED DESCRIPTION

Some embodiments of the disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

While the present invention is described herein by way of example using embodiments, those skilled in the art will recognize that the invention is not limited to the embodiments described, and are not intended to represent the scale of the various components. It should be understood that the detailed description thereto is not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

The present invention discloses a submerged liquid-cooled modular battery system that aims to increase battery life of air-cooled battery modules by bringing down temperature difference between ambient temperature and battery cells, by decreasing heat transfer thermal resistance and removing elements like thermal pads in an effective manner. The submerged liquid-cooled modular battery system is configured to increase heat transfer surface area, and increase heat transfer coefficient inside battery pack enclosure by using a dielectric coolant inside the battery module. The heat transfer coefficient is circulated inside the battery module. The submerged liquid-cooled modular battery system of the present invention is cost effective and has a simple structure.

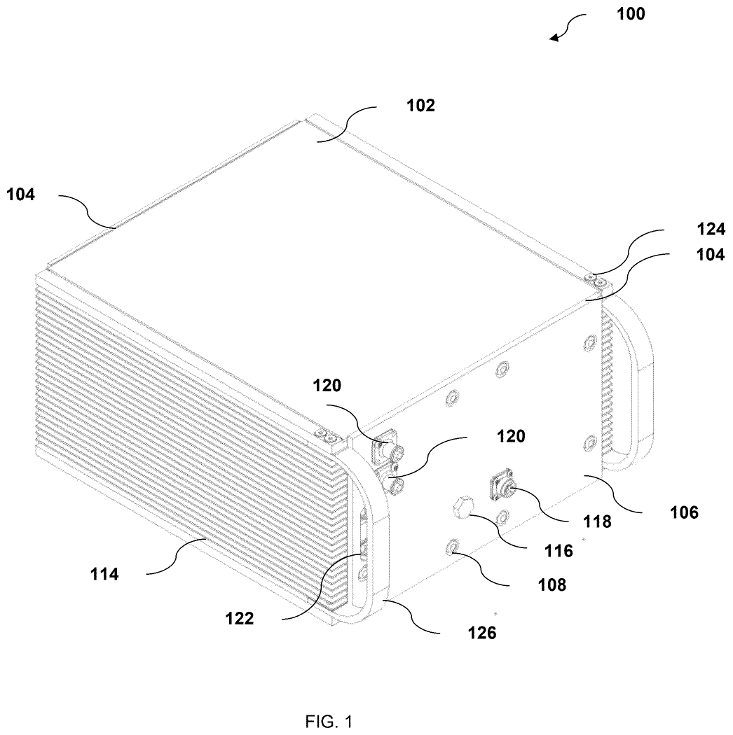

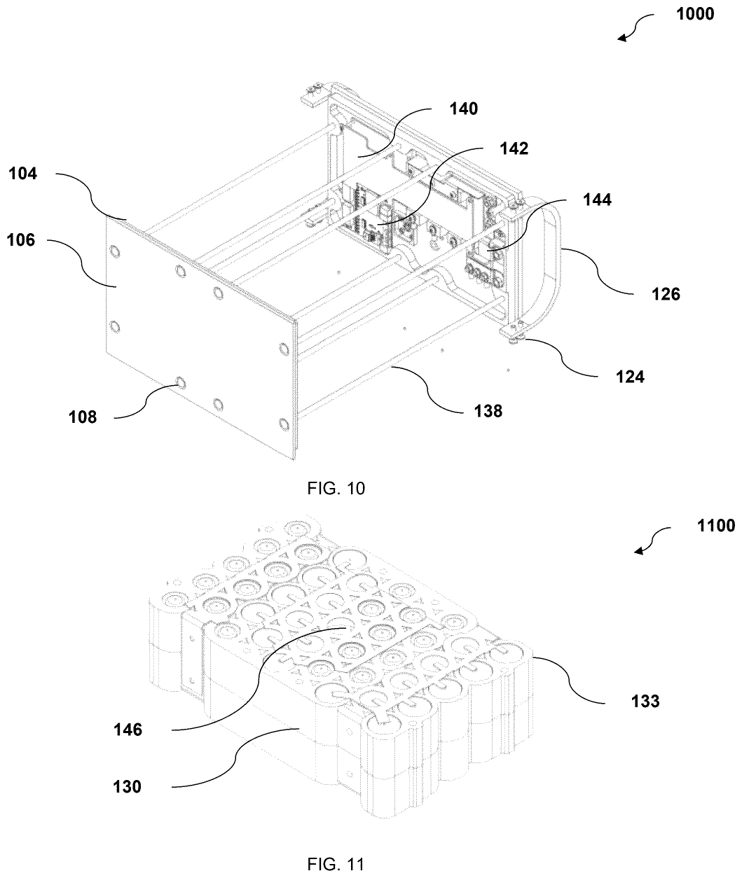

FIG. 1 illustrates an isometric view of a submerged liquid-cooled modular battery system (100), according to an embodiment of the present invention. The submerged liquid-cooled modular battery system (100) comprises of a battery enclosure (102), a plurality of end plates (106), a plurality of gaskets (not shown), a plurality of sealing nuts (108), an aluminium casing (114), a pressure equalization valve (116), and a pair of handles (126). The battery enclosure (102) comprises a pair of open faces (104). The battery enclosure (102) is front portion of the submerged liquid-cooled modular battery system (100). The battery enclosure (102) is configured to enclose the battery or a plurality of batteries. The battery enclosure (102) is further configured to provide space for the battery to be installed inside the battery enclosure (102). The battery is made out of connecting a plurality of battery modules along with a battery management system (shown in FIG. 10). The battery enclosure (102) is further configured to accommodate a battery assembly (shown in FIG. 7), and a battery module assembly (shown in FIG. 7) inside the battery enclosure (102).

In one embodiment, the battery enclosure (102) comprises of a plurality of fins positioned on outer portion of the battery enclosure (102) for heat transfer to ambient air. The plurality of fins are a part of the aluminium casing (114).

In another embodiment, the battery enclosure (102) is made of aluminium metal or any other solid or highly resistive material, using extrusion as the primary process or majorly pressure die casting or with other materials using injection molding.

In yet another embodiment, the battery enclosure (102) comprises of a cover (not shown) which is configured to protect the battery enclosure (102) from any kind of environmental impacts. The cover of the battery enclosure (102) is made of an aluminium material and prepared either through extrusion or pressure die casting.

The pair of open faces (104) are side faces of the submerged liquid-cooled modular battery system (100). The pair of open faces (104) may be configured to be connected with the battery enclosure (102), at outer portion of the battery enclosure (102). The pair of open faces (104) is configured to be detachably coupled with the plurality of end plates (106), at two sides of the submerged liquid-cooled modular battery system (100).

In one embodiment, the pair of open faces (104) may be configured to be detachably coupled with the battery enclosure (102), at sides of the submerged liquid-cooled modular battery system (100), through the plurality of gaskets, or a plurality of clamping elements, or nuts and bolts, or any other fastening element.

In another embodiment, the pair of open faces (104) may be configured to be detachably coupled with the plurality of end plates (106), through the plurality of gaskets, or a plurality of clamping elements, or nuts and bolts, or any other fastening element.

The plurality of end plates (106) is configured to be detachably coupled to each of the pair of open faces (104), through the plurality of gaskets, at the sides of the submerged liquid-cooled modular battery system (100). Each of the plurality of end plates (106) is further configured to accommodate installation of the plurality of sealing nuts (108), through a passage defined by a plurality of holes. The plurality of end plates (106) is further configured to accommodate the installation of a low voltage connector (118), a high voltage connector (120), and fuse elements (122), at outer surface of each of the plurality of end plates (106).

In one embodiment, the plurality of end plates (106) is configured to be detachably coupled to the battery enclosure (102), through the plurality of gaskets, after the dielectric coolant is filled inside the plurality of battery modules (shown in FIG. 7).

In another embodiment, the plurality of end plates (106) is made of primarily nylon or metal or any other solid or highly resistive material.

The plurality of sealing nuts (108) comprises of an integrated seal in the nut itself. There are eight types of sealing nuts (108) which are used in battery models. Each of the plurality of sealing nuts (108) is configured to be fitted on a plurality of studs (shown in FIG. 10). The plurality of sealing nuts (108) is further configured to be tightened on the plurality of studs, in order to sandwich the battery enclosure (102), the plurality of end plates (106), and all other components into a fixed position. At least eight nuts of the plurality of sealing nuts (108) are configured to be attached on each end plate of the plurality of end plates (106).

In one embodiment, the plurality of sealing nuts (108) is made of metal or any other solid or highly resistive material.

The submerged liquid-cooled modular battery system (100) may comprise a plurality of fixed frames (not shown), which are configured to be attached to the battery enclosure (102), at two different side ends of the battery enclosure (102). The plurality of fixed joints may be configured to be attached to the battery enclosure (102), through the plurality of gaskets, or the plurality of clamping elements, or the nuts and bolts, or any other fastening element.

In one embodiment, each of the plurality of fixed joints may be configured to be attached to the plurality of end plates (106), through the plurality of gaskets, or the plurality of clamping elements, or the nuts and bolts, or any other fastening element.

In another embodiment, the plurality of fixed joints may be, but not restricted to, be made of metal or any other solid or highly resistive material.

The plurality of fins may be configured to be positioned on outer portion of the battery enclosure (102) for heat transfer to ambient air. The plurality of fins may be further configured increase heat transfer area and thus reducing convection heat transfer resistance to air from heat sink. The plurality of fins may be further configured to be attached to one side face and another side face of the battery enclosure (102). The plurality of fins may be further configured to be detachably coupled with the one side face and the another side face of the battery enclosure (102), through the plurality of gaskets, or the plurality of clamping elements, or the nuts and bolts, or any other fastening element.

In one embodiment, the plurality of fins may be, but not restricted to, made of a material selected from a group of materials of metal material or any other solid or highly resistive material.

The aluminium casing (114) is configured to provide protective covering to the plurality of fins. The aluminium casing (114) may be configured to protect the plurality of fins from environmental impacts. The aluminium casing (114) is further configured to protect the one side face and the another side face of the battery enclosure (102), from the environmental impacts.

The pressure equalization valve (116) is configured to be doubled up as a port to fill up and drain the dielectric coolant from each of the plurality of battery modules or batteries. The pressure equalization valve (116) is further configured to release pressure which gets build up inside the battery, due to change in environmental pressure or due to increase in level of gas inside the battery.

In one embodiment, the pressure equalization valve (116) may be, but not restricted to, a spring-based pressure relief valve, having a spring configured to hold the pressure equalization valve (116) in a closed position, under normal operation.

In another embodiment, the pressure equalization valve (116) is configured to be in an “open” state to release the gas, if a certain amount of pressure is exceeded than threshold pressure of the battery, or if the pressure in the battery is brough to a certain level close to the threshold pressure.

The low voltage connector (118), the high voltage connector (120), and the fuse elements (122) are the electrical components which are configured to be mounted on the plurality of end plates (106). The low voltage connector (118) is a connection element that comprises of communication interfaces, to connect different electric and electronic devices. The high voltage connector (120) is the connection element which acts like a power connector, and through which the battery actually delivers current or power. The fuse elements (122) acts as a protection element, as it is configured to protect battery circuit, and prevent damage to other components, in conditions of high power or current.

In one embodiment, a plurality of countersunk bolts (124) are provided to fasten each of the fixed joint of the plurality of fixed joints, with at least one handle of the pair of handles (126). The plurality of countersunk bolts (124) may be configured to tighten at least one fixed joint with the plurality of fins, through the at least one handle of the pair of handles (126).

In another embodiment, the plurality of countersunk bolts (124) is configured to be attached to the at least one handle of the pair of handles (126), through protrusions at a surface of the at least one fixed joint of the plurality of fixed joints.

In yet another embodiment, the plurality of countersunk bolts (124) may be, but not restricted to, made of a material selected from a group of materials of stainless steel, metal material or any other solid or highly resistive material.

The pair of handles (126) is configured to be attached to bottom portion of the battery enclosure (102). The pair of handles (126) is further configured to provide grip to side faces of the battery enclosure (102). The pair of handles (126) is further configured to hold firmly the battery enclosure (102) in position. The pair of handles (126) is further configured to be attached to bottom portion of the at least one fixed joint of the plurality of fixed joints.

In one embodiment, the pair of handles (126) is configured to be attached to topmost portion and bottommost portion of the plurality of fins.

In another embodiment, the pair of handles (126) may be, but not restricted to, made of a material selected from a group of materials of stainless steel, metal material or any other solid or highly resistive material.

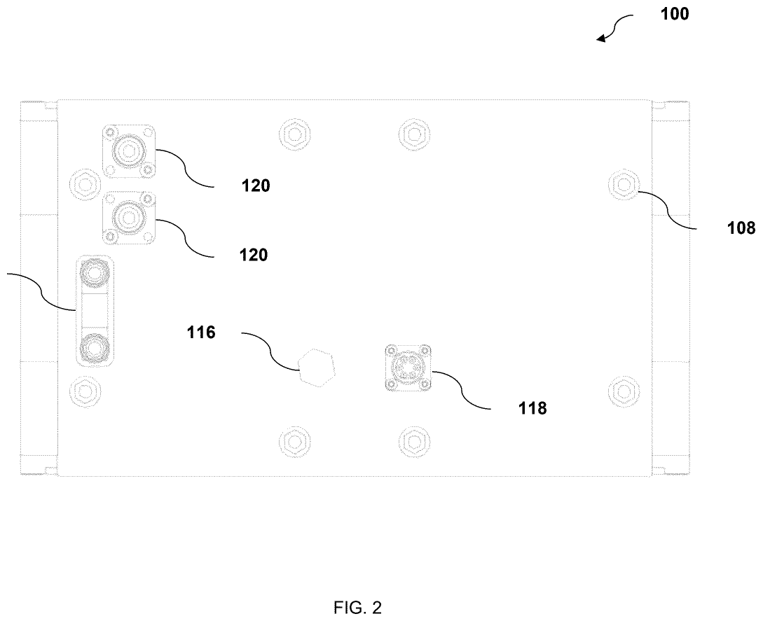

FIG. 2 illustrates a top view of the submerged liquid-cooled modular battery system (100), according to another embodiment of the present invention. The submerged liquid-cooled modular battery system (100) of the FIG. 2 comprises the following components: the plurality of sealing nuts (108), the plurality of fixed), the pressure equalization valve (116), the low voltage connector (118), the high voltage connector (120), and the fuse elements (122). The pair of open faces (104) is detachably coupled with the plurality of end plates (106), through the plurality of gaskets. Each gasket of the plurality of gaskets is basically a liquid gasket which lies between the battery enclosure (102) and the pair of open faces (104). The liquid gasket is applied to the submerged liquid-cooled battery system (100) during assembling of the batteries.

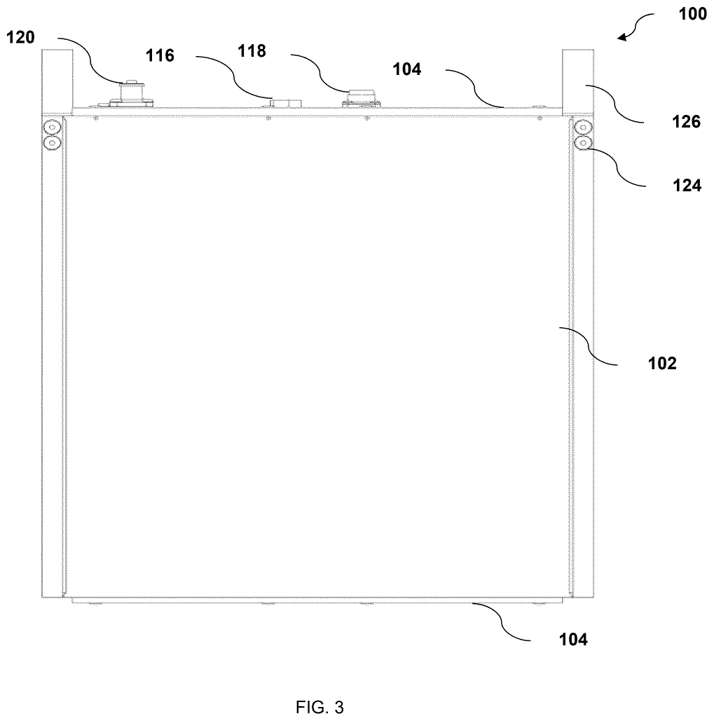

FIG. 3 illustrates a side view of the submerged liquid-cooled modular battery system (100), according to an exemplary embodiment of the present invention. The submerged liquid-cooled modular battery system (100) of the FIG. 3 comprises the battery enclosure (102), the plurality of fixed joints, the pressure equalization valve (116), the low voltage connector (118), the high voltage connector (120), the plurality of countersunk bolts (124), and the pair of handles (126). The low voltage connector (118) and the high voltage connector (120) are configured to be mounted on each of the plurality of end plates (106). The pressure equalization valve (116) ensures that there is no pressure difference between the inside and outside of the battery, due to changes in temperature or atmospheric pressure. The pressure equalization valve (116) is configured to doubles up as the port for filling up and draining the coolant from the battery.

In one embodiment, the pressure equalization valve (116) may be, but not restricted to, made of a material selected from a group of materials of stainless steel, metal material or any other solid or highly resistive material.

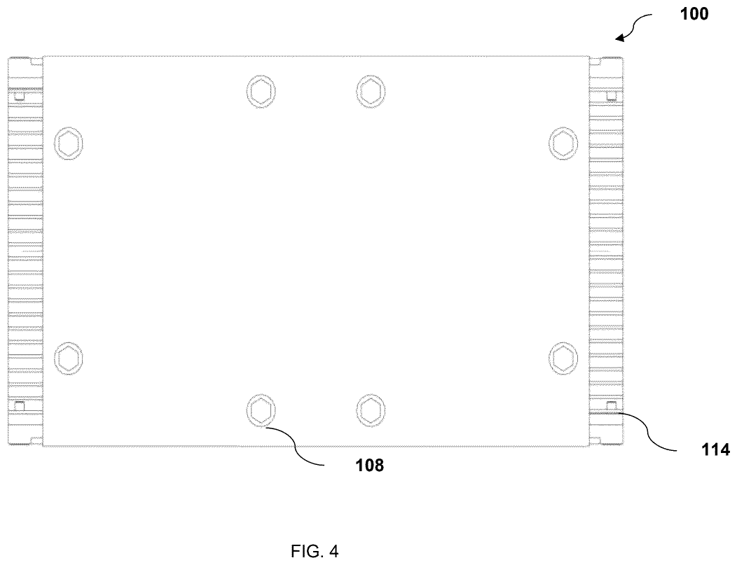

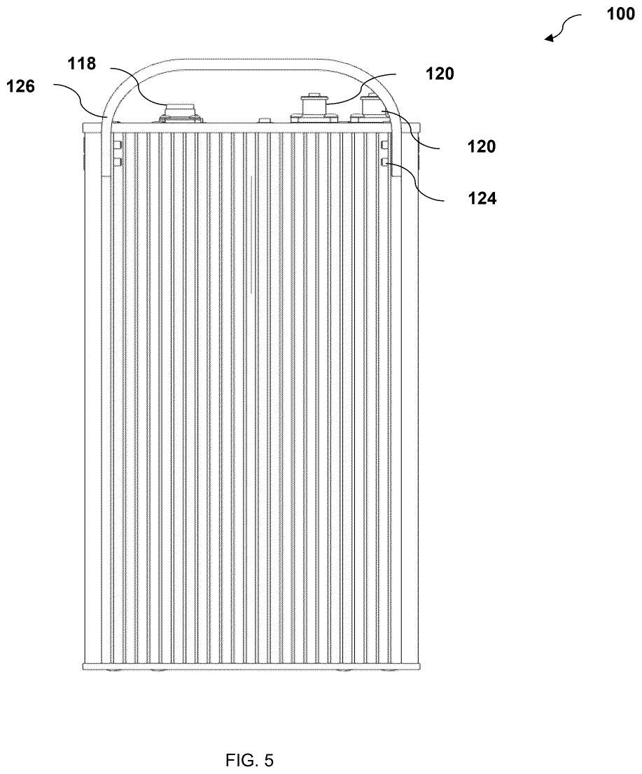

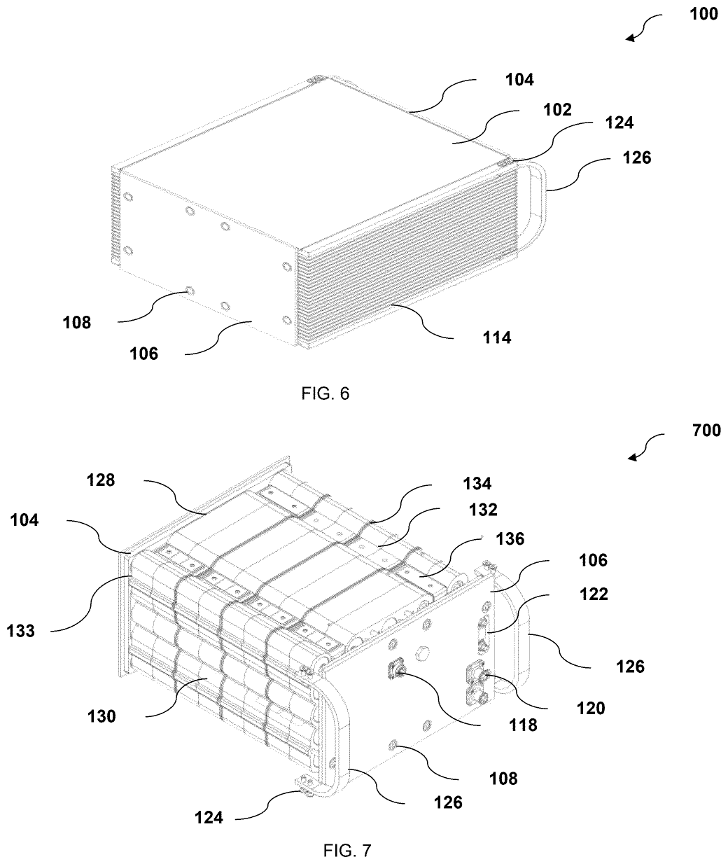

FIGS. 4-6 illustrates a bottom view, another side view, and another isometric view of the submerged liquid-cooled modular battery system (100) respectively, according to different exemplary embodiments of the present invention. The submerged liquid-cooled modular battery system (100) as shown in the FIGS. 4-6 enables sharing of components between battery packs or battery modules of different capacities. The submerged liquid-cooled modular battery system (100) of FIGS. 4-6 comprises a set of tooling used for multiple products, thereby delivering better economics.

FIG. 7 illustrates another isometric view of a submerged liquid-cooled modular battery system (700) without a casing, according to one exemplary embodiment of the present invention. The submerged liquid-cooled modular battery system (700) of FIG. 7 comprises the pair of open faces (104), the plurality of end plates (106), the plurality of sealing nuts (108), the low voltage connector (118), the high voltage connector (120), the fuse elements (122), the plurality of countersunk bolts (124), and the pair of handles (126). A battery assembly (128) is provided comprising of a plurality of batteries or a plurality of battery modules (130), and a plurality of battery current collector plates (132). The battery assembly is basically a single unit comprising of the battery or the plurality of battery modules (130) and other electronic components housed inside it. Each of the plurality of battery modules (130) are configured to be sealed through tightened and detachable arrangement of the plurality of end plates (106) with the pair of open faces (104).

In one embodiment, capacity of each of the plurality of battery modules (130) is modified by changing the plurality of battery current collector plates (132) housed inside each of the plurality of battery modules (130), without integrating any new tools or parts.

In another embodiment, each of the plurality of battery modules (130) are operational at a certain range of voltage and power.

The plurality of battery current collector plates (132) are basically the copper plates which are configured to be connected to all the battery cells, and take current from all the battery cells. The plurality of battery current collector plates (132) is further configured to be bent to form an output terminal for a particular battery module selected from the plurality of battery modules (130).

In one embodiment, the plurality of battery current collector plates (132) are current collectors that connect multiple battery cells, to collect current from each of the battery cells.

In another embodiment, the plurality of battery modules (130) when combined together in a stacked configuration forms a battery module assembly (133). The battery module assembly (133) comprises of the plurality of battery modules (130) in a stacked shape configuration.

The plurality of battery current collector plates (132) is configured to receive the dielectric coolant, and ensure smooth flow of the dielectric coolant throughout the battery assembly (128). The arrangement of the plurality of battery current collector plates (132) within the battery assembly (128) forms flow channels, through which the dielectric coolant moves to the battery assembly (128). The plurality of battery current collector plates (132) is further configured to be fully submerged in the plurality of battery modules (130).

In one embodiment, the plurality of battery current collector plates (132) is configured to be connected with each other in series configuration to provide overall system configuration of voltage and current.

In another embodiment, each of the plurality of battery current collector plates (132) are configured to operate at a specific voltage and current.

Each of the plurality of battery modules (130) comprises a plurality of electrical insulators (134) and a plurality of power terminals (136). The plurality of electrical insulators (134) is configured to provide insulation to each of the plurality of battery modules (130), if the power flowing through the plurality of battery current collector plates (132) exceeds a certain power bearing capacity or threshold power of the battery assembly (128). The plurality of power terminals (136) is configured to provide connection points for any device to be connected to at least one battery module of the plurality of battery modules (130), through communication ports.

In one embodiment, the plurality of electrical insulators (134) is configured to protect the plurality of battery modules (130) from short circuit conditions or any environmental condition.

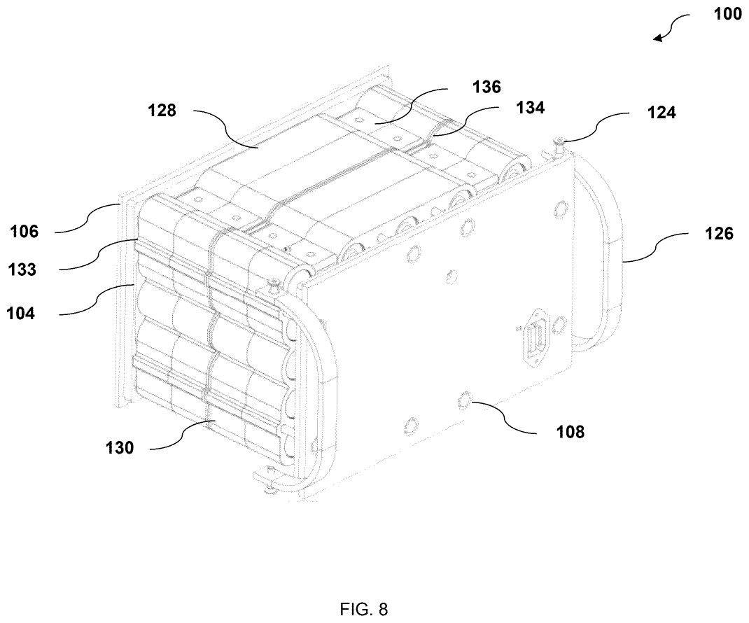

FIG. 8 illustrates another isometric view of the submerged liquid-cooled modular battery system (100) with two modules, according to another exemplary embodiment of the present invention. The submerged liquid-cooled modular battery system (100) of the FIG. 8 comprises the pair of open faces (104), the plurality of end plates (106), the plurality of sealing nuts (108), the low voltage connector (118), the high voltage connector (120), the fuse elements (122), the plurality of countersunk bolts (124), the pair of handles (126), the battery assembly (128), the plurality of battery modules (130), the plurality of battery current collector plates (132), the plurality of electrical insulators (134) and the plurality of power terminals (136). The plurality of electrical insulators (134) and the plurality of power terminals (136) are configured to operate at a specific load voltage and load power.

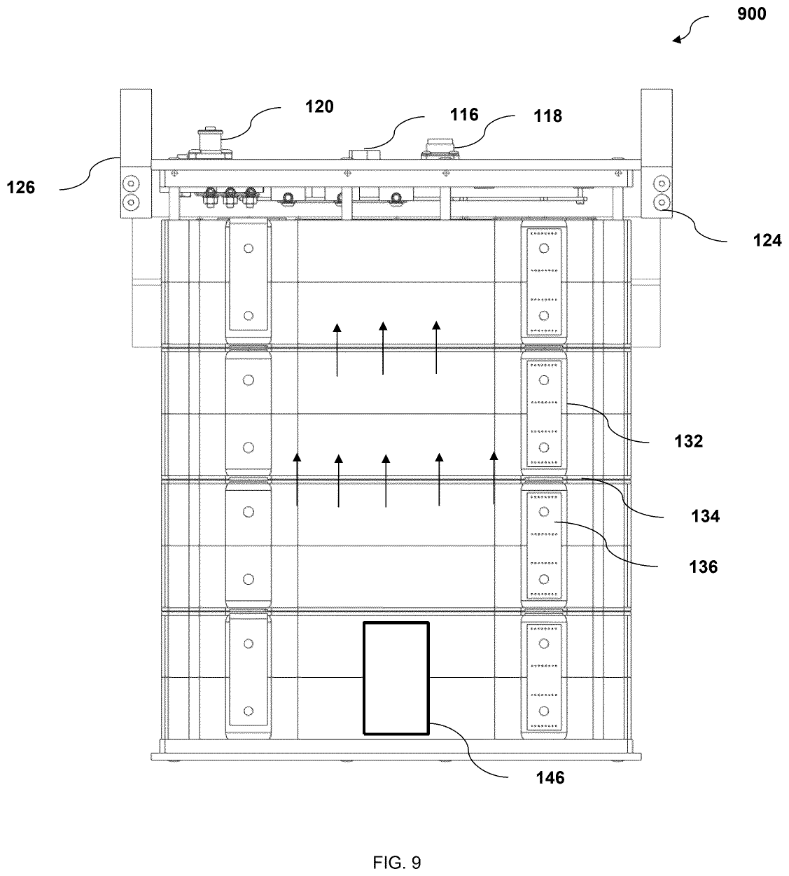

FIG. 9 illustrates another side view of the submerged liquid-cooled modular battery system (900) with a transparent casing, according to one exemplary embodiment of the present invention. The submerged liquid-cooled modular battery system (900) comprises of the pressure equalization valve (116), the low voltage connector (118), the high voltage connector (120), the plurality of countersunk bolts (124), the pair of handles (126), the plurality of battery current collector plates (132), the plurality of electrical insulators (134), the plurality of power terminals (136), and a coolant pump (146). The coolant pump (146) is configured to be integrated within the battery assembly (128). The coolant pump (146) is further configured to provide a passage for the dielectric coolant to circulate through the plurality of battery current collector plates (132). The coolant pump (146) is further configured to intake dielectric coolant from bottom of at least one battery module, and pump the dielectric coolant inside the battery module assembly (128).

In one embodiment, the flow of the dielectric coolant returns to bottom of each of the plurality of battery modules (130), through the flow channels, to exchange heat with a heat sink. After the dielectric coolant is filled inside the plurality of battery modules (130) through the coolant pump (146), the plurality of end plates (106) is detachably coupled to the battery enclosure (102), through the plurality of gaskets.

In another embodiment, upon filing the dielectric coolant inside the plurality of battery modules (130) through the coolant pump (146), the dielectric coolant starts flowing in an upward direction, throughout the battery assembly (128). Circulation of the dielectric coolant inside the plurality of battery modules (130) helps in keeping the temperatures of the plurality of battery current collector plates (132) homogeneous. The coolant pump (146) positioned inside the battery assembly (128) is configured to establish circulation of the dielectric coolant throughout within the battery assembly (128). From the top of the battery the flow returns to the bottom of the battery through the flow channels on either side of the battery, exchanging heat with the heatsinks. This flow is also supported by natural convection as hot fluid tends to rise and cold fluid sinks. The flow of the dielectric coolant inside the plurality of battery modules (130) is in the axial direction of the plurality of battery current collector plates (132).

In yet another embodiment, the dielectric coolant on the inside of the at least one battery module reduces the convective heat transfer resistance and thus reduces the overall temperature difference between the plurality of battery current collector plates (132) and ambient environment.

In yet another embodiment, the coolant pump (146) is made of plastic material, steel or any hard metal, semiconducting material, or any other solid or highly resistive material.

FIG. 10 illustrates isometric view of a submerged liquid-cooled modular battery system (1000) with hidden battery modules, according to another exemplary embodiment of the present invention. The submerged liquid-cooled modular battery system (1000) of FIG. 10 comprises the pair of open faces (104), the plurality of end plates (106), the plurality of sealing nuts (108), the plurality of countersunk bolts (124), the pair of handles (126), a plurality of studs (138), a battery management system (BMS) (140), an Internet of Things (IoT) gateway and thermal controller (142), and a plurality of electrical bus bars (144). The plurality of studs (138) is configured to be installed throughout each of the plurality of battery modules (130), to constrain the plurality of battery current collector plates (132) with at least one end plate. The plurality of studs (138) is further configured to provide clamping force between at least two end plates of the plurality of end plates (106), in order to hold firmly the battery assembly (128).

In one embodiment, the plurality of studs (138) may be, but not restricted to, made of a material selected from a group of materials of stainless steel, metal material or any other solid or highly resistive material.

The battery management system (140) comprises of an assembly of battery cells electrically organized in a row x column matrix configuration to enable delivery of targeted range of voltage and current for a duration of time against expected load scenarios. The BMS (140) is configured to safely optimize power performance of the battery, as per desired user requirements.

The Internet of Things (IoT) gateway (142) is a centralized hub that connects IoT devices and sensors to the battery assembly (128), through communication ports, in order to process data related with the power requirements of the battery. The power requirements of the battery may be, but not, restricted to battery load power requirements, battery thermal power requirements, or the like.

In one embodiment, the thermal controller (142) is configured to control the battery thermal power requirements, with respect to the battery power management in the two or three-wheeler vehicles.

In another embodiment, the plurality of electrical bus bars (144) is configured to connect high voltage equipment's and low voltage equipment's with the battery assembly (128).

FIG. 11 illustrates an isometric view of the battery module (1100), according to one embodiment of the present invention. The battery or the battery module (1100) comprises of the plurality of battery modules (130) and the coolant pump (146). The battery module (1100) comprises of a protrusion at a centre of the at least one battery module of the plurality of battery modules (130). The protrusion as shown is basically a hole that provides passage for installation of the coolant pump (146). The coolant pump (146) is configured to be inserted inside the protrusion, in order to direct flow of the dielectric coolant within the plurality of battery modules (130), in a homogenous manner.

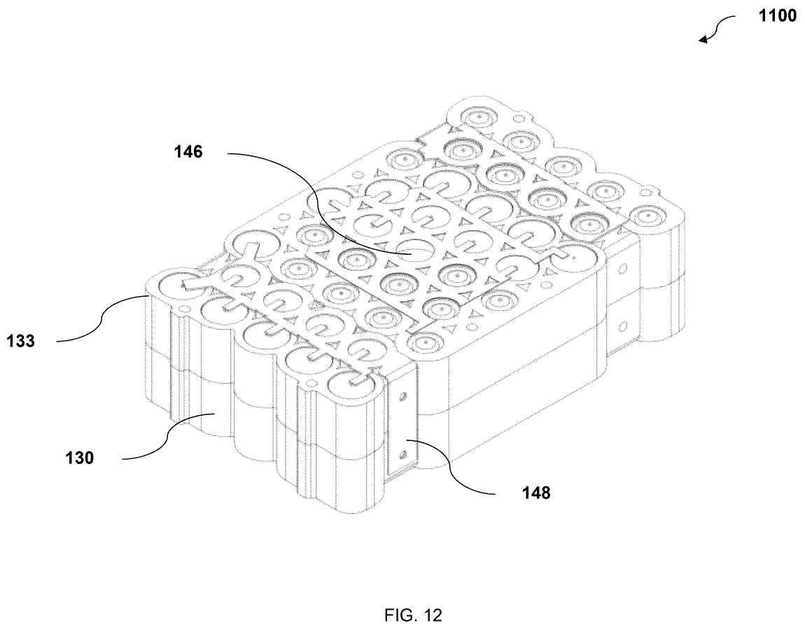

FIG. 12 illustrates top view of the battery module (1100), according to another embodiment of the present invention. The battery module (1100) as shown in the FIG. 12 comprises of the plurality of battery modules (130), the coolant pump (146), and a negative terminal (148) of the battery module (1100). The negative terminal (148) of the battery module (1100) is configured to allow the connection of any high voltage or low voltage equipment's with the battery module (1100), to pass current through at least one battery module of the plurality of battery modules (130), within the battery module (1100).

In one embodiment, the coolant pump (146) comprises of holes or insertion spaces which are configured to tighten the battery current collector plates (132) in place. The battery current collector plates (132) further comprises threaded inserts (not shown) inside each of the plates, and bolts can be used to tighten connections onto each of these battery current collector plates (132).

In another embodiment, the negative terminal (148) is an actual terminal configured to allow connection of any high voltage or low voltage equipment's with the plurality of battery modules (130).

The plurality of battery current collector plates (132) which are fully submerged thus maximize heat transfer surface area, thereby reducing temperature variation within at least one battery cell, and can be fast charged compared to other air-cooled pack with a small heat transfer area. Other than this the increased heat transfer area results in lower temperature difference within the battery cells which in turn allows for fast charging the battery cells, compared to the battery modules available in the markets without compromising on the safety. The increased thermal mass also improves the safety along with other active and passive safety element like the BMS (140).

The reduced temperature difference with the ambient air helps in increasing the battery life, thereby taking battery module level performance closer to the cells used to make the battery module. Moreover, the arrangement of the plurality of battery modules (130) also enables extreme modularity of the design of the battery system (100), as the capacity/voltage of the battery can be modified by changing the number of battery modules without changes in the plurality of endplates (106) or the aluminium casing (114).

Various modifications to these embodiments are apparent to those skilled in the art from the description. The principles associated with the various embodiments described herein may be applied to other embodiments. Therefore, the description is not intended to be limited to the embodiments but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

1. A submerged liquid-cooled modular battery system (100), comprising:
a battery enclosure (102) having a pair of open faces (104);
a plurality of end plates (106) detachably coupled to each of the pair of open faces (104); and
a battery assembly (128) having a plurality of battery modules (130), wherein each of the plurality of battery modules (130) are configured to be sealed through tightened and detachable arrangement of the plurality of end plates (106) with the pair of open faces (104), wherein the battery assembly (128) comprises of a plurality of battery current collector plates (132) and a coolant pump (146), wherein the coolant pump (146) is integrated within the battery assembly (128), and configured to provide a passage for dielectric coolant to circulate through the plurality of battery modules (130), and wherein the coolant pump (146) is configured to intake dielectric coolant from bottom of at least one battery module, and pump the dielectric coolant inside the battery assembly (128);
wherein the battery enclosure (102), the pair of open faces (104), the plurality of end plates (106), the battery assembly (128), the plurality of battery modules (130), the plurality of battery current collector plates (132), and the coolant pump (146) are integrated as a single unit to form the submerged liquid-cooled modular battery system (100).

2. The submerged liquid-cooled modular battery system (100) as claimed in claim 1, wherein arrangement of the plurality of battery current collector plates (132) within the battery assembly (128) forms flow channels, through which the dielectric coolant moves to the battery assembly (128).

3. The submerged liquid-cooled modular battery system (100) as claimed in claim 2, wherein flow of the dielectric coolant returns to bottom of each of the plurality of battery modules (130), through the flow channels, to exchange heat with a heat sink.

4. The submerged liquid-cooled modular battery system (100) as claimed in claim 3, wherein the plurality of end plates (106) is configured to be detachably coupled to the battery enclosure (102) after the dielectric coolant is filled inside the plurality of battery modules (130).

5. The submerged liquid-cooled modular battery system (100) as claimed in claim 1, wherein the battery enclosure (102) comprises of a plurality of fins configured for heat transfer to ambient air.

6. The submerged liquid-cooled modular battery system (100) as claimed in claim 1, wherein capacity of each of the plurality of battery modules (130) is modified by changing the plurality of battery current collector plates (132) housed inside each of the plurality of battery modules (130), without integrating any new tools or parts.

7. The submerged liquid-cooled modular battery system (100) as claimed in claim 1, wherein the battery enclosure (102) further comprises a plurality of studs (138) installed throughout each of the plurality of battery modules (130), to constrain the plurality of battery current collector plates (132) with at least one end plate, and provide clamping force between at least two end plates of the plurality of end plates (106) to hold firmly the battery assembly (128).

8. The submerged liquid-cooled modular battery system (100) as claimed in claim 1, wherein the battery enclosure (102) further comprises a pressure equalization valve (116) configured to be doubled up as a port to fill up and drain the dielectric coolant from each of the plurality of battery modules (130).

9. The submerged liquid-cooled modular battery system (100) as claimed in claim 1, wherein the submerged liquid-cooled modular battery system (100) further comprises a low voltage connector (118), high voltage connector (120), and fuse elements (122) mounted on the plurality of end plates (106).

10. The submerged liquid-cooled modular battery system (100) as claimed in claim 1, wherein the plurality of battery current collector plates (132) is configured to be fully submerged in the plurality of battery modules (130).

11. The submerged liquid-cooled modular battery system (100) as claimed in claim 1, wherein the plurality of battery current collector plates (132) is connected with each other in series configuration to provide overall system configuration of voltage and current.

12. The submerged liquid-cooled modular battery system (100) as claimed in claim 1, wherein the battery enclosure (102) is made of aluminium metal or any other solid or highly resistive material, using pressure die casting or with other materials using injection molding.

13. The submerged liquid-cooled modular battery system (100) as claimed in claim 12, wherein cover of the battery enclosure (102) is made of an aluminium material and prepared either through extrusion or pressure die casting.

14. The submerged liquid-cooled modular battery system (100) as claimed in claim 1, wherein the plurality of end plates (106) is made of metal or any other solid or highly resistive material.

15. The submerged liquid-cooled modular battery system (100) as claimed in claim 1, wherein the coolant pump (146) is made of plastic material, copper windings, steel or any hard metal, semiconducting material, or any other solid or highly resistive material.
